(19) United States
(12) Patent Application Publication
(10) Pub. No.: US 2018/0185774 A1
(43) Pub. Date: Jul. 5, 2018

(54) WATER PURIFIER

(71) Applicant: INFINITUS (CHINA) COMPANY LTD, Jiang Men (CN)

(72) Inventors: Yan ZHOU, Jiang Men (CN); Junhua NING, Jiang Men (CN); Guangrong LIAO, Jiang Men (CN); Jianping WANG, Jiang Men (CN)

(73) Assignee: INFINITUS (CHINA) COMPANY LTD, Jiang Men (CN)

(21) Appl. No.: 15/622,646

(22) Filed: Jun. 14, 2017

(30) Foreign Application Priority Data
Jan. 4, 2017 (CN) 201710004261.4

(51) Int. Cl. B01D 35/143; B01D 27/14; B01D 27/10; B01D 35/157; B01D 35/30; C02F 1/00; C02F 1/44; C02F 1/28

(52) U.S. Cl. CPC B01D 35/143; B01D 27/146; B01D 27/101; B01D 35/1573; C02F 2101/20; C02F 1/003; C02F 1/44; C02F 1/283; B01D 2201/24; B01D 35/30

(57) ABSTRACT

The present application discloses a water purifier, which comprises a composite water path structure; a filter cartridge; a universal direction water outlet structure; a housing; a sliding module; and a locking module; a plurality of flow meters; and a controller. The water purifier provided by the present invention has its water path structure, filter cartridge, water outlet structure, housing, way for replacing the filter cartridge as well as way for detecting service life of the filter cartridge improved, to obtain significantly improved working and using effects.

### CROSS REFERENCE TO RELATED APPLICATIONS

This application claims the priority of Chinese Patent Application No. 201710004261.4, filed on Jan. 4, 2017, the contents of which are incorporated herein by reference in its entirety.

### FIELD OF THE INVENTION

The present invention relates to the technical field of water purifiers, and particularly to a water purifier.

### BACKGROUND OF THE INVENTION

The application of water purifiers in the field of drinking water will allow the phenomenon of “climate sickness” to become history soon, which effectively addresses endemic diseases caused by excessive harmful mineral substances in underground water in many places, therefore, water purifiers have become more and more popular in real life.

Most of the current water purifiers are filter cartridge-type water purifiers in which tap water flows in turn through several filter cartridges connected in series to achieve the object of being purified. The water path structure, for connecting the filter cartridges in series, of the conventional filter cartridge-type purifier is a linear water path structure, and then a plurality of quick coupling pipes are provided in the linear water path structure to achieve the object of outputting multiple kinds of water by one water purifier. However, the conventional way of providing a plurality of quick coupling pipes in the linear water path structure to achieve the object of outputting multiple kinds of water by one water purifier has a certain defect, that is, a complex structure, and the complex structure may cause technical problems such as a low reliability and being apt to leak water.

In addition, in the process of filtering water, multiple purification procedures such as foreign matter filtering and removing, harmful substance absorbing, and sanitizing by a plurality of filter cartridges are required to be performed. However, some of the conventional filter cartridges have no capability in removing heavy metal and other ionic state contaminants, and possibly cause insufficient capability in removing heavy metals; and some of them are manufactured in a very complex process, and it is likely to bring in some contaminants in the process of manufacturing. Although the filter material is required to be sanitized by corresponding procedures before being added into the filter cartridge, risks caused by careless or omission still exist. Further, if a mineral substance is soaked in the purified water for a long time, it is possible to breed certain microorganisms in the water, and if the water with the microorganisms is drunk directly by a people, the physical health of the people may be affected.

In addition, the conventional water purifiers on the market generally have water outlet structures with a fixed output direction, and some of the water purifiers have water outlet structures with an output direction manually selectable, however, once the direction is determined, it will be fixed. For users of water purifiers, the water outlet structure with output direction selectable provides too less directions for selection, and the fixation of its water outlet port may cause lots of inconvenience in using water, therefore, such water purifiers fail to meet various requirements from the users.

Currently, most of water purifiers may replace the filter cartridge by opening the outer cover from the upper side and taking out the filter cartridge from the main body component, and some of water purifiers, for more conveniently replacing filter cartridges, enlarge the replacement space and increase the volume of the water purifier. Furthermore, when replacing the filter cartridge from the upper side, the operator cannot see the position for connecting the filter cartridge, thus the replacement is extremely inconvenient, and enlarging the replacement space may increase the area occupied by the water purifier, and cause its cost to be too high.

In addition, for most of the water purifiers on the market, the cover-opening/closing process is performed by using hooks, hinges, or directly sleeving the outer cover onto the cover base, and in some of the water purifiers, the process is performed by attracting of magnets, and generally adopts the cover opening direction in conformity with the attraction direction of the magnets. However, the means by hooks, hinges, or sleeving the outer cover onto the cover base all render poor customer experience, and in the case that the cover opening direction is consistent with the attraction direction of the magnets, it is not easy to open the cover if the attracting force between the magnets is too large, while the cover is apt to be disconnected and the gap is difficult to control if the attracting force between the magnets is too small.

Currently, most of the water purifiers have all of their filter cartridges detected by a water flow detection device, and if it is found that one of the filter cartridges reaches the end of its service life, the user may be informed to replace all of the filter cartridges. However, the service lives of the filter cartridges in one water purifier are different from each other, and if a plurality of filter cartridges are detected together, the service life of each of the filter cartridges cannot be distinguished, which is a kind of resource waste for those filter cartridges having a longer service life.

### SUMMARY OF THE INVENTION

In view of the above technical problems in the prior art, the present application innovatively proposes a water purifier with a novel structure, in which, the water purifier with a plurality of filter cartridges connected in series by means of a plate-type water path structure is designed innovatively, and a water outlet passage is provided on each of the filter cartridges connected in series except the first filter cartridge, and then an external switching valve is operated to selectively output multiple kinds of water flowing through different kinds and numbers of filter cartridges, thus addressing the technical problems in the prior art of a complicated structure, a low reliability, being apt to leak water caused by achieving the object of outputting various kinds of water by means of quick coupling pipes; furthermore, the filter cartridges having various functions are provided on a plurality of filter cartridge bases for purifying the water, and a unique universal direction water outlet structure is employed to achieve input and output of water, and a filter cartridge base mounted with a filter cartridge is mounted on the water purifier base by a sliding module, thus achieving a convenient replacement of the filter cartridge in the condition that the water purifier has a small volume. Further, the service lives of the filter cartridges are counted by flow meters mounted on the plate-type water path structure, and the service lives of the filter cartridges can be detected and counted by using the flow meters with the number thereof less than the number of the filter cartridges. Finally, a front cover and a rear cover which are provided with magnets reliably pack the filter cartridges, and the rear cover is enabled to be more easily opened when detaching the filter cartridges.

In order to achieve the above objects, the present invention provides the following technical solutionsprovided by the present application.

A water purifier, comprising:

a composite water path structure, comprising a water inlet passage, a plurality of water outlet passages, and at least three filter cartridge bases connected in series and in communication with each other via a water channel, wherein the water inlet passage is in communication with the filter cartridge base, located at a start end, of all of the filter cartridge bases connected in series, and the plurality of water outlet passages are respectively in communication with the rest plurality of filter cartridge bases, and the water outlet passage is provided with a valve configured to control its opening and closing;

a filter cartridge, fixed onto the filter cartridge base and in communication with the filter cartridge base, and comprising a multi-stage filtering structure;

a universal direction water outlet structure via which an external water inlet pipe is in communication with the water inlet passage and an external water outlet pipe is in communication with the water outlet passage, and the universal direction water outlet structure being rotatable with respect to the composite water path structure;

a housing, comprising a base and a front cover fixedly connected, and a rear cover detachably connected to the front cover by a magnet;

a replacement device, comprising a sliding module slidably connecting the base and the composite water path structure, to allow the composite water path structure to slide on the top surface of the base, and a locking module configured to lock the composite water path structure and the base; and a detection device, comprising a plurality of flow meters arranged on the water channel, with any adjacent two filter cartridge bases being provided therebetween with the flow meter; and a controller electrically connected to all of the flow meters via a wire, and configured to monitor and record the flowed amount of water and capable of resetting the numerical value of the flowed amount.

Preferably, in the water purifier, the composite water path structure is formed by splicing a water path upper plate, a water path lower plate, and a rib arranged on the water path upper plate and the water path lower plate, and the filter cartridge base is fixed onto the water path upper plate; and

both the number of the filter cartridge bases and the number of the filter cartridges are three, and the filter cartridge base in communication with the water inlet passage is the first filter cartridge base, and the filter cartridge bases connected in series downstream the first filter cartridge base are sequentially the second filter cartridge base and the third filter cartridge base, and the water channel between the first filter cartridge base and the second filter cartridge base is the first water channel, and the water channel between the third filter cartridge base and the second filter cartridge base is the second water channel.

Preferably, in the water purifier, all of the filter cartridge bases have the same structure, and each comprises a filter cartridge water outlet port, a filter cartridge water inlet port, a connecting plate, a pressing plate, a sealing ring, a water channel inlet port, a water channel outlet port, and a fastening screw;

both of the filter cartridge water outlet port and the filter cartridge water inlet port are arranged on the connecting plate;

the filter cartridge water outlet port and the filter cartridge water inlet port are butt-joined to the water channel outlet port and the water channel inlet port respectively, and are sealed by the sealing ring, and in every adjacently arranged two filter cartridge bases, the filter cartridge water inlet port of the upstream one is in communication with the filter cartridge water outlet port of the downstream one, and the filter cartridge water outlet ports of the second filter cartridge base and the third filter cartridge base are respectively in communication with the second water outlet passage and the third water outlet passage of a plate-type water outlet passage;

the connecting plate is arranged between the pressing plate and the water path upper plate; and

the pressing plate is fixed onto the water path upper plate by the fastening screw.

Preferably, in the water purifier, the connecting plate is a rotatable connecting plate;

the filter cartridge base further comprises a first position-limiting structure configured to restrict the rotatable connecting plate; and

the first position-limiting structure consists of a column distributed on the connecting plate, and a circular-arc slot distributed on the water path plate.

Preferably, in the water purifier, the filter cartridge comprises a first filtering structure and a second filtering structure, wherein the first filtering structure comprises: a central tube; a folded filter membrane sleeved outerside the central tube, with a second cavity being arranged between the filter membrane and the central tube; and a housing sleeved outside the filter membrane, with a first cavity being arranged between the housing and the filter membrane.

Preferably, in the water purifier, the housing comprises a cylindrical housing body, a top cover provided with a recess, a bottom cover provided with a water inlet/outlet assembly, wherein:

the top end opening of the central tube is an inclined port, and is inserted into the recess, and the bottom end of the central tube has a sealing ring sleeved thereon;

a separator is provided respectively between the first cavity and the bottom cover and between the second cavity and the bottom cover;

the water inlet/outlet assembly comprises: a straight water inlet port and a straight water outlet port which are in communication with the filter cartridge base, a side water inlet port, a side water outlet port and a switch structure;

the straight water inlet port is in communication with the first cavity via the side water inlet port; and

the straight water outlet port is in communication with the central tube via the side water outlet port.

Preferably, in the water purifier, the switching structure comprises a spring and a rubber ball distributed at the top end of the straight water inlet port and the straight water outlet port; and the rubber ball is arranged respectively between the spring and the straight water outlet port and between the spring and the straight water inlet port.

Preferably, in the water purifier, the second filtering structure comprises:

a third cavity arranged inside the housing and located at the bottom of the first filtering structure, wherein the central tube is in communication with the water inlet/outlet assembly via the third cavity; and

a filter material provided in the third cavity and capable of filtering heavy metal ions.

Preferably, in the water purifier, the second filtering structure is a sintered active carbon rod arranged between the filter membrane and the central tube, and the second cavity is located between the sintered active carbon rod and the central tube.

Preferably, in the water purifier, the second filtering structure is a mineral substance layer having an adding function arranged in the first cavity.

Preferably, in the water purifier, the universal direction water outlet structure comprises:

a water inlet/outlet joint in connection and communication with the external water inlet pipe and the external water outlet pipe, and a water path joint in connection and communication with the water inlet passage and the water outlet passage,

the water path joint is a multilayer recessed structure consisting of a plurality of circular grooves sleeved co-axially with gradually decreased internal diameters;

the number of layers of the recessed structure and the number of the circular grooves are equal to each other, and are equal to the sum of the number of the water inlet passage and the number of the water outlet passage;

the water inlet/outlet joint is provided with a plurality of layered passages, and the plurality of layered passages are matchfully muff-coupled to and one-to-one communicated with the plurality of circular grooves; and

a clamp assembly locking the water inlet/outlet joint and the water path joint, and allowing both of them to rotate with respect to each other.

Preferably, in the water purifier, the clamp assembly comprises:

two semi-circular clamps capable of being butt-jointed, and the two clamps being capable of cooperatively clamping the flanges of the water inlet/outlet joint and the water path joint; and

a locking screw connecting the two clamps.

Preferably, in the water purifier, both the water inlet/outlet joint and the water path joint are a stepped inverted cone structure, and the water inlet/outlet joint is provided with a sealing ring at the outlet of each passage.

Preferably, in the water purifier, both the font cover and the rear cover are provided with a plurality of magnets, and the number and position of the provided magnets in the front cover one-to-one correspond to the number and position of the provided magnets in the rear cover.

Preferably, in the water purifier, the portion, connected to the rear cover, of the front cover is provided with a sliding groove, and the portion, in contact with the front cover, of the rear cover is provided with a bump capable of protruding into the sliding groove, and the relative sliding between the front cover and the rear cover can be achieved by means of the sliding groove and the bump.

Preferably, the water purifier further comprises:

a convex-shaped fastener arranged at the top end of the rear cover, and a fastening groove arranged at the top end of the front cover and capable of being fastened to the convex-shaped fastener; and

a second position-limiting structure arranged on the front cover and configured to prevent the rear cover from exceedingly sliding with respect to the front cover.

Preferably, in the water purifier, the water path upper plate is vertically fixed to the top of the sliding module, and the sliding module comprises:

slidably connected guide sleeve and guide post, wherein the guide sleeve is arranged inside a slider, and the slider is fixedly connected to the water path upper plate; and

slidably connected sliding component and guide rail, wherein the sliding component is a translating slider, or a rolling pulley block, or a ball, or a ball set.

Preferably, in the water purifier, the locking module is fixed onto the base by a fastening screw, and the locking module comprises:

a locating member arranged on the composite water path structure, and translating along with the composite water path structure; and

a locating groove provided on the base, and capable of fastening the locating member;

a force receiving member arranged on the surface of the composite water path structure and configured to drive the locating member to move; and

a connecting member, configured to connect the force receiving member and the locating member, wherein the locating member and the connecting member are an integral structure and are connected to the force receiving member via a connecting screw.

Preferably, in the water purifier, the flow meter comprises a first flow meter arranged on the first water channel, and a second flow meter arranged on the second water channel, and the controller is provided with buttons respectively configured to reset the numerical value of the flowed amount through the three filter cartridges.

The technical solution of the present application can at least achieve the following technical effects:

1. In the present application, by means of the plate-type water path structure, a plurality of filter cartridges are connected in series, and a water outlet passage is provided in each of the filter cartridge bases except the first filter cartridge base, and further, by externally operating a switching valve, multiple kinds of water are outputted selectively, thus addressing the technical problem in the prior art of a complex structure, a low reliability, and being apt to leak water caused by achieving the purpose of outputting multiple kinds of water by means of quick coupling pipes.

2. The connecting plate configured to connect the filter cartridges is fixed to the water path upper plate by the pressing plate, and is sealed by a sealing ring, thus addressing the problem in the prior art of water leakage caused by threaded connection.

3. When the filter cartridge base rotates, the rotatable connecting plate may be driven to rotate together, to allow the water outlet port of the filter cartridge base and the water inlet port of the filter cartridge base to be respectively offset from the water channel outlet port and the water channel inlet port, thus addressing the problem of leakage of water residued in the plate-type water path structure after the filter cartridge is detached.

4. The water path joint of the water purifier provided by the present application is a multilayer recessed structure, and the multilayer recessed structure is provided with a plurality of circular grooves, and the water inlet/outlet joint is provided with a plurality of layered passages, and the plurality of layered passages are matchfully muff-coupled to the plurality of circular grooves, thus the water inlet pipe and the water outlet pipe of the water inlet/outlet joint can select the water outlet direction within 360 degrees, thereby achieving layered fluid communication of a plurality of sets of water path, meeting the requirement of various water outlet directions from users of the water purifier, improving the user experience, and having a high applicability and a high popularization value.

5. The water purifier provided by the present application has various kinds of filter cartridges, for example, a filter cartridge capable of having large particles of foreign matter (such as, suspensions, rust, and insect eggs, etc.) removed by a folded PP cotton, and then having pentavalent arsenic in the water removed by an arsenic-removal filter material in the third cavity, thereby integrating the functions of adsorption, interception and filtration, and addressing the technical problems that the conventional pp cotton filter cartridges have no capability in removing heavy metal and other ionic state contaminants and possibly cause insufficient capability of the whole machine in removing heavy metal; a filter cartridge having water pass through the filter membrane, and then having heavy metal and organic matter in the water absorbed by a sintered active carbon rod, thus integrating the sintered active carbon rod and the filter membrane, thereby absorbing foreign smells and residual chlorine, and also having an interception effect on particles and the like; and also a filter cartridge having water activated by medical stone and then filtered by the filter membrane, to allow the water, after being activated by a mineral substance and before entering the central tube, to have bacteria, microorganisms intercepted again, to ensure that the flown activated water is clean and nontoxic, thus addressing the technical problem that activated water is contaminated since the mineral substance is not thoroughly sanitized in its production process and microorganisms are bred in the water due to the mineral substance being soaked in the water for a long time.

6. The recess is provided in the top cover, and the central tube is inserted into the recess, such that only when the level of water is higher than the level of the central tube in the recess, can the water flow out of the central tube, thus, reducing the space between the central tube and the top cover effectively, and addressing the technical problem in which a water dropping phenomenon may occur in the case that the water outlet port of the water purifier is just closed caused by the pressure generated by the residual air in the large space between the central tube and the top cover, and also addressing the technical problem in which the water flows into the central tube before filling the whole second cavity so that the usage area of the filter material is reduced, the filter material is wasted and the filter material being not soaked breeds bacteria.

7. Due to the design of the folded shape of the filter membrane, the filtration area is increased in a large degree, and the filtration effect is improved.

8. The design of the water inlet/outlet structure enables the rubber balls to close the water inlet passage and the water outlet passage with the effect of the spring force of the spring in the case that the filter cartridge is not mounted in the water path, thus effectively addressing the technical problem of water leakage after the filter cartridge is removed.

9. The water path upper plate of the water purifier provided by the present application is fixed over the sliding module, and the user may push and pull the water path upper plate connected with the filter cartridge base and the filter cartridge to achieve a convenient replacement of the filter cartridge in a condition that the water purifier has a small volume. The water path upper plate is further provided with a locking module, and the user may unlock or lock the water path upper plate by the moving of the locking slider, to allow the water path upper plate and the water purifier base to have a simple and compact connecting structure with a reliable function.

10. The rear cover and the front cover of the water purifier provided by the present application are movably connected by the magnetic force of the magnets, and since an attracting force perpendicular to the main attracting force direction is small, the rear cover may be opened from a direction perpendicular to the main attracting force direction with a small manual force; and the rear cover and the front cover of the water purifier are connected and assembled together through a fastener connection, such that the rear cover cannot be opened from the main attracting force direction. The cover opening mechanism of the water purifier has a simple and compact structure, and is safe and reliable, thus improving the user's experience, and has a high popularization value.

11. In the water purifier provided by the present application, the flow meter is arranged on the water channel, thus may detecting and counting service lives of the filter cartridges by using flow meters less than the filter cartridges in number, such that the water purifier can display the service lives of the filter cartridges separately, which facilitates the replacement of the filter cartridges by the users, saves resources, and greatly improves the user experience.

### DESCRIPTION OF THE DRAWINGS

For more clearly illustrating the embodiments of the present invention or the technical solutions in the prior art, the drawings used when describing the examples or the prior art will be briefly described hereinafter. Apparently, the drawings in the following description are only examples of the present application, and for a personan ordinary skilled in the art, other drawings may be obtained based on the provided drawings without any creative work.

FIG. 1 is a schematic view showing the water path structure of a water purifier provided according to an embodiment of the present application;

FIG. 2 is a schematic view showing the structure and connection of the water channel of the water path structure of a water purifier provided by an embodiment of the present application;

FIG. 3 is an exploded view of the filter cartridge base of a water purifier provided by an embodiment of the present application;

FIG. 4 is a schematic view showing the structure of the back side of the connecting plate of a water purifier provided by an embodiment of the present application;

FIG. 5 is a schematic view showing the structure of the universal direction water outlet structure of a water purifier provided by an embodiment of the present application;

FIG. 6 is an exploded view of the universal direction water outlet structure of a water purifier provided by an embodiment of the present application;

FIG. 7 is a schematic view showing a structure of the water path joint of a water purifier provided by an embodiment of the present application;

FIG. 8 is a schematic view showing the structure of the water inlet/outlet joint of a water purifier provided by an embodiment of the present application;

FIGS. 9 to 11 are respectively schematic views showing the structures of three embodiments of the filter cartridge of a water purifier provided by an embodiment of the present application;

FIG. 12 is a schematic view showing the structure of the central tube of the filter cartridge of a water purifier provided by an embodiment of the present application;

FIG. 13 is a schematic view showing the structure of the bottom cover of the filter cartridge of a water purifier provided by an embodiment of the present application;

FIG. 14 is a schematic view showing the combination of the water path upper plate and the water purifier base of a water purifier provided by an embodiment of the present application;

FIG. 15 is a schematic view showing the structure of the sliding module of a water purifier provided by an embodiment of the present application;

FIG. 16 is a schematic view showing the structure of the locking module of a water purifier provided by an embodiment of the present application in an unlocked state;

FIG. 17 is a schematic view showing the structure of the locking module of a water purifier provided by an embodiment of the present application in a locked state;

FIG. 18 is a schematic view showing the combination of the front cover and the rear cover of a water purifier provided by an embodiment of the present application;

FIG. 19 is a schematic view showing the first step in opening the rear cover of a water purifier provided by an embodiment of the present application; and

FIG. 20 is a schematic view showing the distribution of magnets on the bottom cover of a water purifier provided by an embodiment of the present application; and

FIG. 21 is a schematic view showing the second step in opening the rear cover of a water purifier provided by an embodiment of the present application.

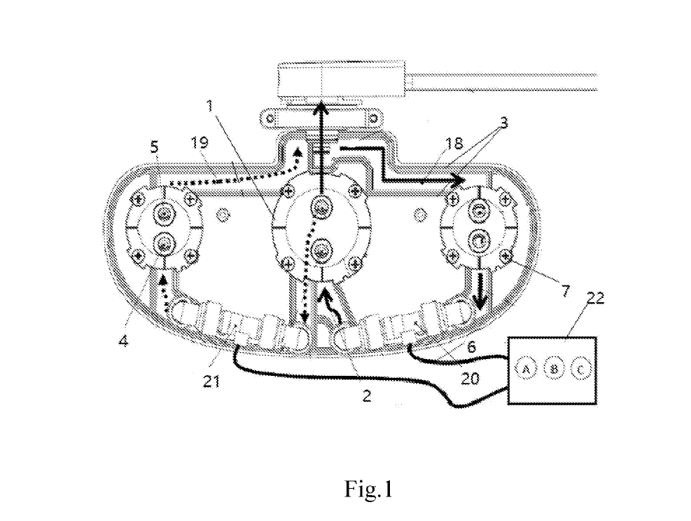

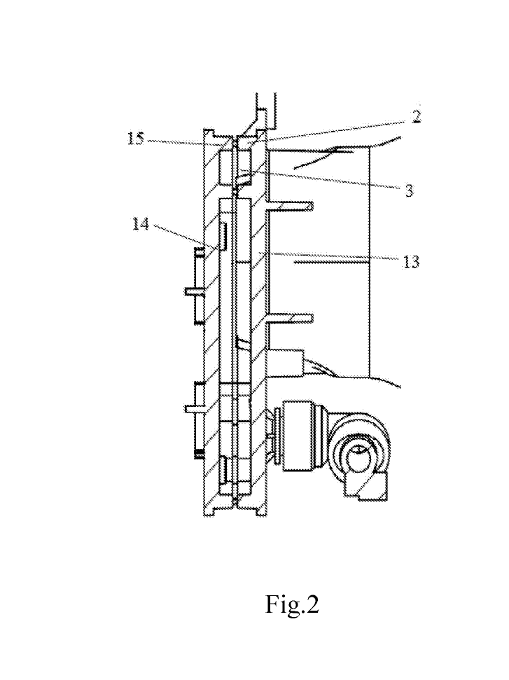

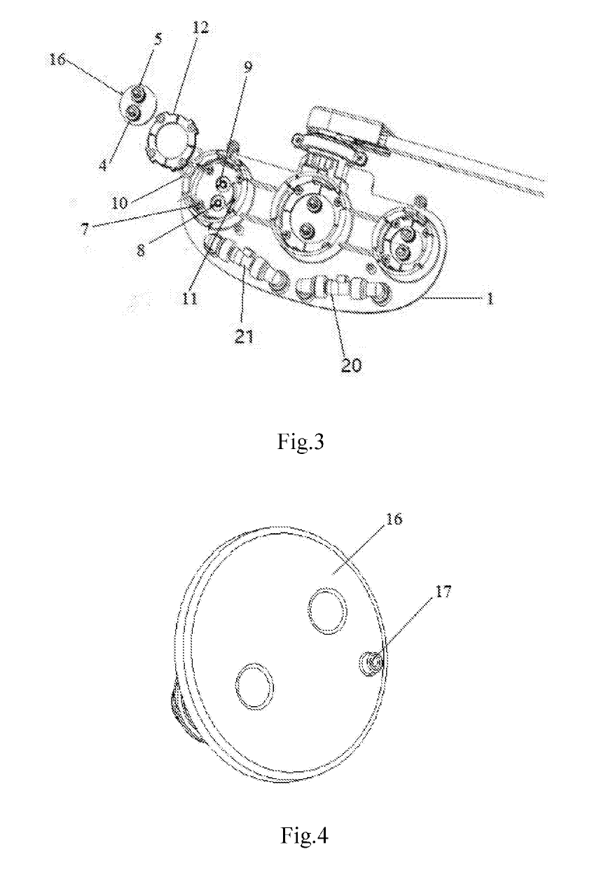

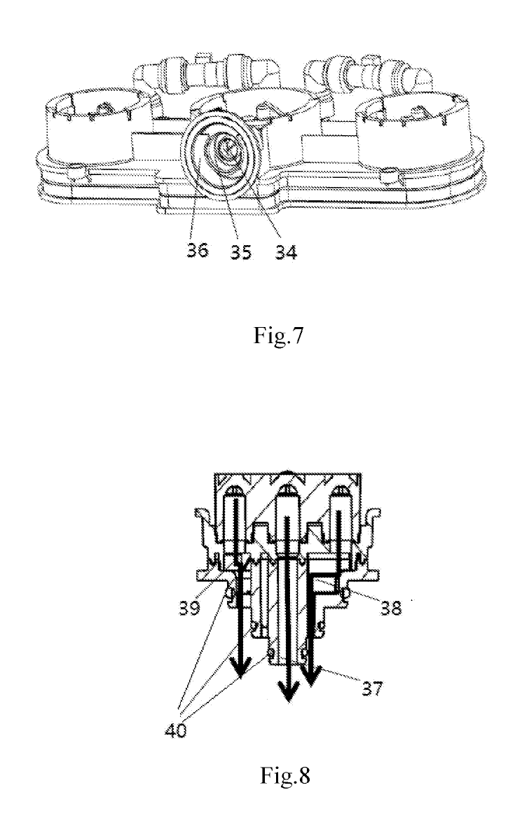

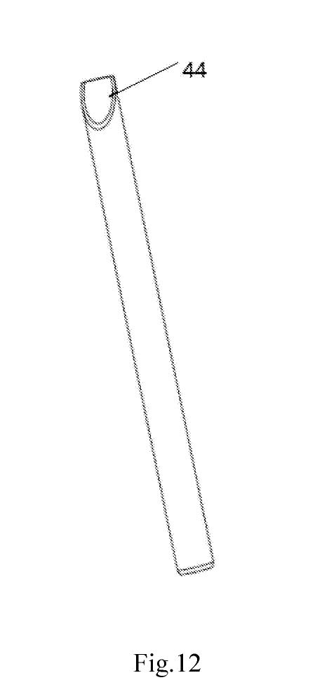

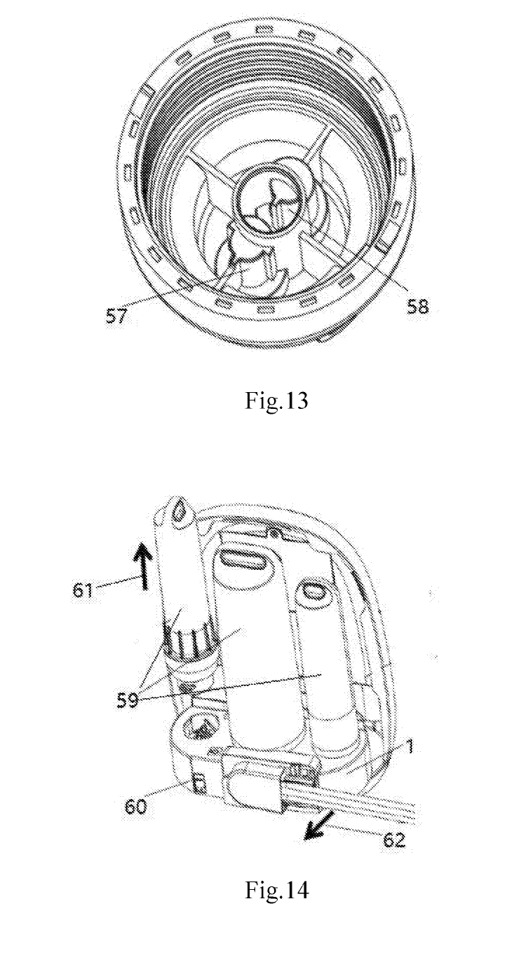

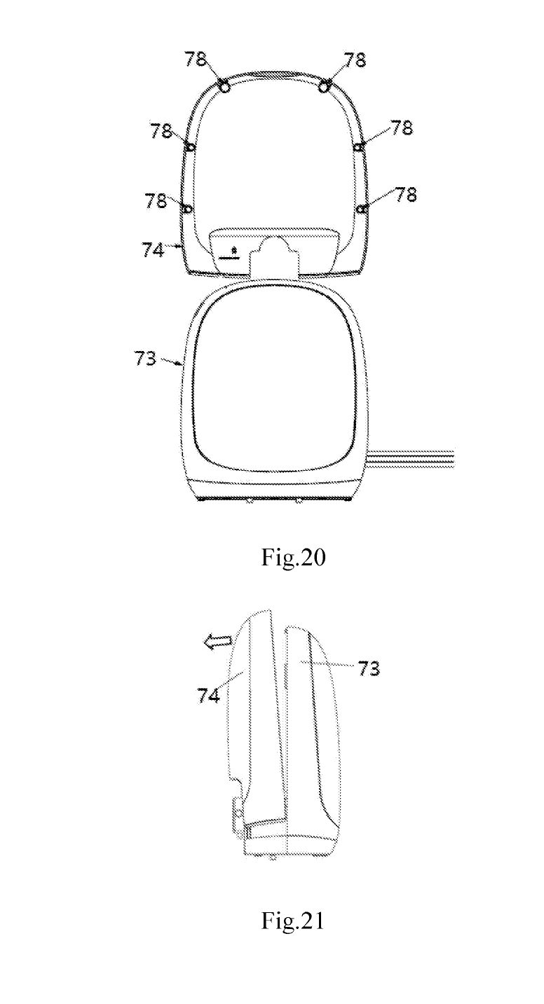

Denotations of reference numerals in FIGS. 1 to 21 are as follows:

| | | | |
|---|---|---|---|
| 1 | filter cartridge base, | 2 | water channel, |
| 3 | upper plate rib, | 4 | filter cartridge water inlet port, |
| 5 | filter cartridge water outlet port, | 6 | wire, |
| 7 | fastening screw, | 8 | water channel inlet port, |
| 9 | water channel outlet port, | 10, 40, 55 | sealing ring, |
| 11 | circular-arc slot, | 12 | pressing plate, |
| 13 | water path upper plate, | 14 | water path lower plate, |
| 15 | lower plate rib, | 16 | connecting plate, |
| 17 | column, | 18 | water inlet passage, |
| 19 | water outlet passage, | 20 | first flow meter, |
| 21 | second flow meter, | 22 | controller, |
| 23 | water inlet/outlet joint, | 24 | water path joint, |
| 25 | clamp assembly, | 26 | water inlet pipe, |
| 27 | water outlet pipe, | 28, 30 | locking screw, |
| 29, 31 | clamp, | 32 | water inlet/outlet joint flange, |
| 33 | water path joint flange, | 34, 35, 36 | circular groove, |
| 37, 38, 39 | layered passages inside the water inlet/outlet joint, | 41 | top cover, |
| 42 | housing body, | 43 | recess, |
| 44 | central tube, | 45 | first cavity, |
| 46 | filter membrane, | 47 | second cavity, |
| 48 | third cavity, | 49 | spring, |
| 50 | rubber ball, | 51 | straight water outlet port, |
| 52 | straight water inlet port, | 53 | bottom cover, |
| 54 | separator, | 56 | mineral substance having an adding |
| | | | function |
| 57 | side water inlet port, | 58 | side water outlet port, |
| 59 | filter cartridge, | 60 | locking module, |
| 61 | direction in which the filter cartridge is taken out, | | |
| 62 | direction in which the water path upper plate is pulled, | | |
| 63 | guide sleeve, | 64 | slider, |
| 65 | fixing screw, | 66 | guide post, |
| 67 | water purifier base, | 68 | locating groove, |
| 69 | force receiving member, | 70 | connecting member, |
| 71 | connecting screw, | 72 | locating member, |
| 73 | front cover, | 74 | rear cover, |
| 75 | locating groove, | 76 | convex-shaped fastener, |
| 77 | front cover magnet, | 78 | rear cover magnet, |
| 79 | second position-limiting structure, and | 80 | sintered active carbon rod. |

### DETAILED EMBODIMENTS OF THE INVENTION

The technical solution of the present application is described in detail hereinafter in conjunction with the drawings in order to enable the solution of the present application to be more clearly understood by those skilled in the art, however not to limit the protection scope of the present application.

Referring to FIGS. 1 to 4, a water purifier is provided by an embodiment of the present application, which comprises: at least three filter cartridge bases 1, a water path upper plate 13, a water path lower plate 14, and a plate-type water path structure formed by upper plate rib 3 distributed on the water path upper plate 13 and lower plate rib 15 distributed on the water path lower plate 14.

The plate-type water path structure comprises a water channel 2, a water outlet passage 19, and a water inlet passage 18.

The at least three filter cartridge bases 1 are connected in series through the water channel 2.

The water inlet passage 18 is in communication with one of the filter cartridge bases at two ends of the at least three filter cartridge bases 1 connected in series;

Each of the other filter cartridge bases 1 other than the filter cartridge base 1 in communication with the water inlet passage 18 is provided with the water outlet passage 19 which may be selectively opened and closed, and all the filter cartridge bases 1 are distributed on the water path upper plate 13;

It is to be noted that the water path upper plate 13 and the water path lower plate 14 are integrally formed by heat fusion, and the upper plate rib 3 and the lower plate rib 15 form the plate-type water path structure.

The at least three filter cartridge bases 1 have the same structure and each comprise: a filter cartridge water outlet port 5, a filter cartridge water inlet port 4, a connecting plate 16, a pressing plate 12, a sealing ring 10, a water channel inlet port 8, a water channel outlet port 9 and a fastening screw 7.

Both the filter cartridge water outlet port 5 and the filter cartridge water inlet port 4 are arranged on the connecting plate 16.

The filter cartridge water outlet port 5 and the filter cartridge water inlet port 4 are butt-joined to the water channel outlet port 9 and the water channel inlet port 8 respectively and are sealed by the sealing ring 10.

The connecting plate 16 is arranged between the pressing plate 12 and the water path upper plate 13.

The pressing plate 12 is fixed onto the water path upper plate 13 by the fastening screw 7. The connecting plate 16 is fixed by the pressing of the pressing plate 12, and the sealing ring 10 is provided to allow the entire water path structure has a good tightness, which replaces the threaded connection means in the prior art.

Starting from one end of the filter cartridge base 1 which is in communication with the water inlet passage 18, the water channel outlet port 9 of each of the filter cartridge bases 1 connected in series is connected to the water channel inlet port 8 of the next filter cartridge base 1 through the water channel 2, meanwhile, the water outlet passage 19 is in communication with the water channel outlet port 9 of a corresponding filter cartridge base 1. It is to be understood that a plurality of filter cartridge bases 1 are connected in series through the water channels 2, the water channel outlet port 9 of the other filter cartridge bases 1 except the two filter cartridge bases at the two ends of the at least three filter cartridge bases 1 connected in series is connected to the water channel inlet port 8 of a next filter cartridge base 1 connected in series thereto through the water channel 2, and the water channel outlet port 9 of each of the other filter cartridge bases 1 except the filter cartridge base 1 being in communication with the water inlet passage 18 is provided with the water outlet passage 19.

The connecting plate 16 is a rotatable connecting plate, the arrangement of which is implemented by an appropriate space formed by the pressing plate 12 and the water path upper plate 13 and an appropriate pressing force from the pressing plate 12.

The filter cartridge base 1 also comprises a first position-limiting structure configured to restrict the rotatable connecting plate, to control a rotation angle of the connecting plate 16.

The first position-limiting structure consists of a column 17 distributed on the connecting plate 16 and a circular-arc slot 11 distributed on the water path upper plate 13.

The water outlet passage 19 is provided with a switching valve configured to selectively open and close the water outlet passage 19. In the case that the water outlet passage 19 corresponding to one of the filter cartridge bases 1 connected in series is opened, no water flows through other filter cartridge bases connected in series downstream the filter cartridge base 1, thus the function that a variety of water can be discharged from the water purifier is achieved by selectively opening and closing the water outlet passage 19.

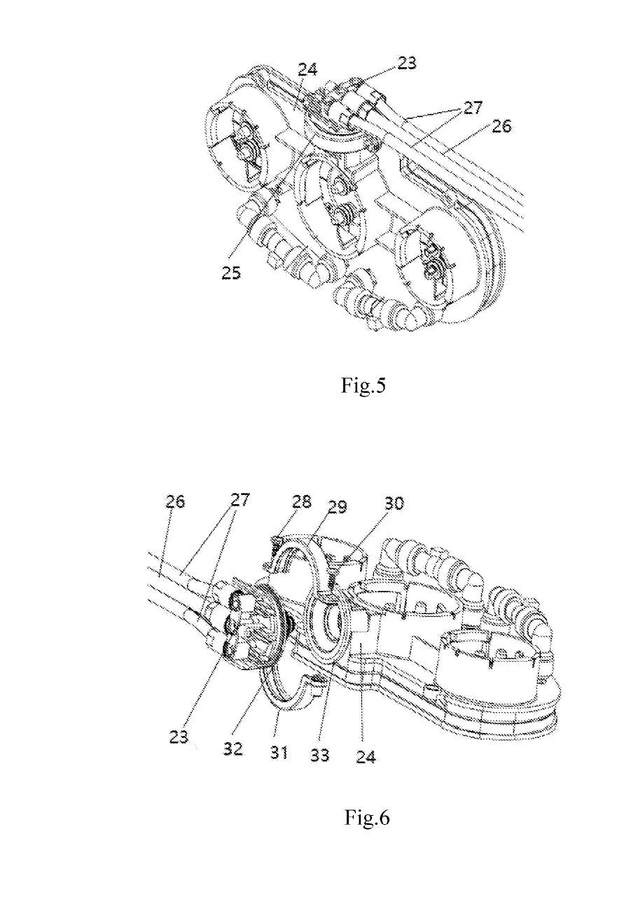

Referring to FIGS. 5 to 8, the water purifier provided by an embodiment of the present application further comprises a water inlet pipe 26, a water outlet pipe 27 and a universal direction water outlet structure, the water inlet pipe 26 and the water outlet pipe 27 are in communication with the water inlet passage 18 and the water outlet passage 19 through the universal direction water outlet structure, respectively.

The universal direction water outlet structure comprises a water inlet/outlet joint 23 connected to the water inlet pipe 26 and the water outlet pipe 27, and a water path joint 24 connected to the water inlet passage 18 and the water outlet passage 19.

The water path joint 24 is a multilayer recessed structure which is provided with a plurality of circular grooves 34, 35, 36. The number of layers of the recessed structure is equal to the number of the circular grooves 34, 35, 36 and to the sum of the number of the water inlet passage 18 and the number of the water outlet passages 19.

The water inlet/outlet joint 23 is provided with a plurality of layered passages 37, 38, 39 which are matchfully muff-coupled to the plurality of circular grooves 34, 35, 36 respectively, and the water inlet/outlet joint 23 is provided with a sealing ring 40 at the outlet of each of the passages, for separating the passages of the water inlet/outlet joint 23.

The universal direction water outlet structure further comprises a clamp assembly 25 provided with a groove. The water inlet/outlet joint 23 and the water path joint 24 are respectively provided with a flange 32 and a flange 33 matching the groove, respectively. The water path joint 24 is connected to the water inlet/outlet joint 23 through the clamp assembly 25. The clamp assembly 25 comprises two semi-arc-shaped clamps 29, 31 which are connected by a locking screw 28, and the locking screw 28. The two semi-arc-shaped clamps 29, 31 are combined to form a circular clamp assembly 25 such that the water inlet/outlet joint 23 can be rotated by 360 degrees as desired.

Both the water inlet/outlet joint 23 and the water path joint 24 are a stepped inverted cone structure.

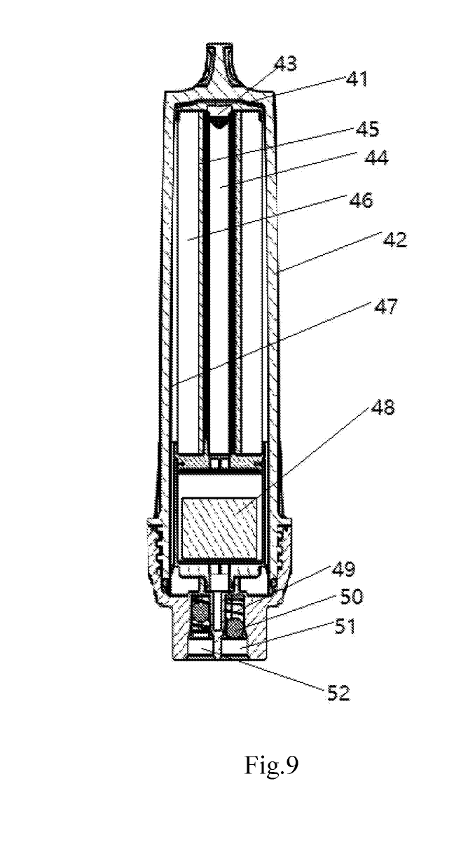

Referring to FIGS. 9 to 13, the water purifier provided by an embodiment of the present application further comprises filter cartridges 59 which are in communication with the filter cartridge bases 1 respectively in a one-to-one corresponding manner. The filter cartridges 59 comprises a central tube 44, a housing body 42, a top cover 41, a bottom cover 53 provided with a water inlet/outlet assembly, a filter membrane 46 distributed outside the central tube 44, a first cavity 45 distributed between the filter membrane 46 and the housing body 42, and a second cavity 47 distributed between the central tube 44 and the filter membrane 46. The water inlet/outlet assembly is in communication with the first cavity 45 and the central tube 44, respectively. The second cavity 47 is in communication with the central tube 44 through a clearance between an upper end of the central tube 44 and the top cover 41. The previously described filter cartridge structure can accomplish a basic filtering function. The water fills the first cavity 45 from bottom to top and continues to enter the second cavity 47 after being filtered through the filter membrane 46. When water in the second cavity 47 gradually rises to the upper end of the central tube 44, the water flows into the central tube 44 through the clearance between the central tube 44 and the top cover 41, and then flowing out of the central tube 44 via the water inlet/outlet assembly of the bottom cover 53 to enter the next filter cartridge base 1 and filter cartridge 59. Wherein the filter membrane 46 can be designed in a folded shape, which greatly increases the effective filtration area of the filter membrane 46. The filter membrane 46 can be embodied in various kinds, for example, it can be a nanometer alumina fiber membrane which can remove submicron matter (such as inorganic nanoscale particles of foreign matter, organic matter, microorganisms, micro-molecular structure, humic acid, protein, polysaccharides, viruses and bacteria, etc.) via the electrosorption principle.

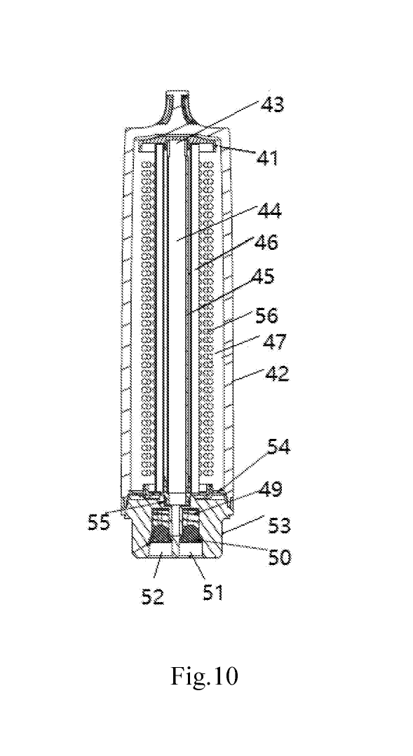

When a mineral substance 56 (for example, medical stone) having an adding function is provided in the first cavity 45, the filter cartridge 59 has an effect of activating water in addition to the function of filtering water. In this case, the structure of the filter cartridge 59 is as shown in FIG. 10. The water is first activated by the medical stone and then filtered through the filter membrane 46. It is to be noted that the substance added in the first cavity 45 may also be a drug having a therapeutic or health care effect. The type of substance added depends on demands of different consumers.

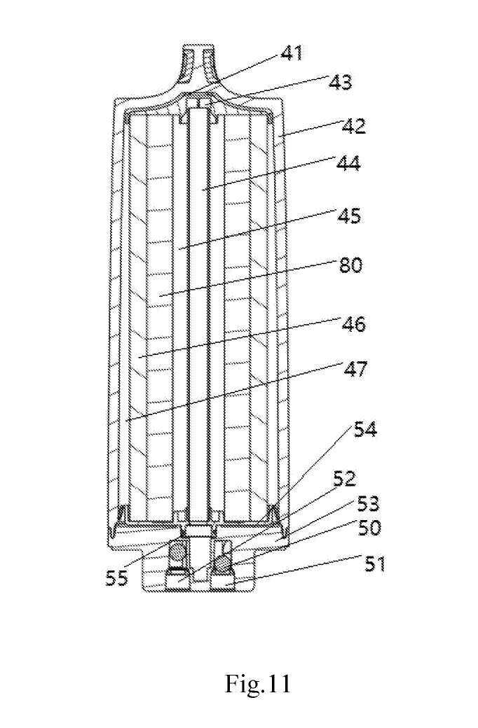

A sintered active carbon rod 80 is provided between the filter membrane 46 and the central tube 44, and in this case, the structure of the filter cartridge 59 is as shown in FIG. 11, which utilizes the function of the sintered active carbon rod 80 for adsorbing the heavy metals and organic substances to purify water.

A third cavity 48 containing a filter material is provided under the filter membrane 46 and the central tube 44. In this case, the structure of the filter cartridge 59 is as shown in FIG. 9. The central tube 44 is in communication with the water inlet/outlet assembly through the third cavity 48. Wherein the filter membrane 46 of the filter cartridge 59 shown in FIG. 9 may be a folded PP cotton, while the filter material in the third cavity 48 may be an arsenic-removal filter material. The water in the filter cartridge 59 may have large particles of foreign matter (such as suspensions, rust, insect eggs, etc.) removed by the PP cotton first, and then remove a highly toxic trivalent arsenic and pentavalent arsenic in the water using the arsenic-removal filter material, thus integrating the functions of adsorption, interception and filtration.

A recess 43 is provided in the center of the top cover 41 into which the upper end of the central tube 44 is inserted. The cross-section of the upper end of the central tube 44 is slanted so that only when the level of water reaches the upper end of the central tube 44 in the recess 43, can the water flow out of the central tube 44, thus, reducing the space between the central tube 44 and the top cover 41 effectively, and addressing the technical problem in which a water dropping phenomenon may occur in the case that the water outlet port of the water purifier is just closed caused by the pressure generated by the residual air in the large space between the central tube 44 and the top cover 41, and also addressing the technical problem in which the water flows into the central tube 44 before filling the whole cavity of the filter cartridge so that the usage area of the filter material is reduced, the filter material is wasted and the filter material being not soaked breeds bacteria.

The water inlet and outlet assembly comprises: a straight water inlet port 52 and a straight water outlet port 51 which are in communication with the filter cartridge base 1, a side water inlet port 57, a side water outlet port 58 and a switch structure. The straight water inlet port 52 is in communication with the first cavity 45 through the side water inlet port 57. The straight water outlet port 51 is in communication with the central tube 44 through the side water outlet port 58.

The switch structure comprises a spring 49 and a rubber ball 50 which are distributed above the straight water inlet port 52 and the straight water outlet port 51. The rubber ball 50 is disposed between the spring 49 and the straight water outlet port 51 and between the spring 49 and the straight water inlet port 52. When the filter cartridge 59 is not mounted onto the filter cartridge base 1, the rubber ball 50 closes the straight water inlet port 52 and the straight water outlet port 51 with the spring force of the spring 49, thus effectively addressing the technical problem of water leakage after removal of the filter cartridge 59.

The water purifier further comprises separators 54 provided between the first cavity 45 and the bottom cover 53 and between the second cavity 47 and the bottom cover 53, and a sealing ring 40 provided around a lower end of the central tube 44.

Referring to FIGS. 14 to 17, one water purifier provided by an embodiment of the present application further comprises a water purifier base 67 and a sliding module which is provided on the water purifier base 67 for connecting the water purifier base 67 and the water path upper plate 13. The water path upper plate 13 is vertically fixed directly above the sliding module for pushing and pulling the water path upper plate 13 in a horizontal plane by a user.

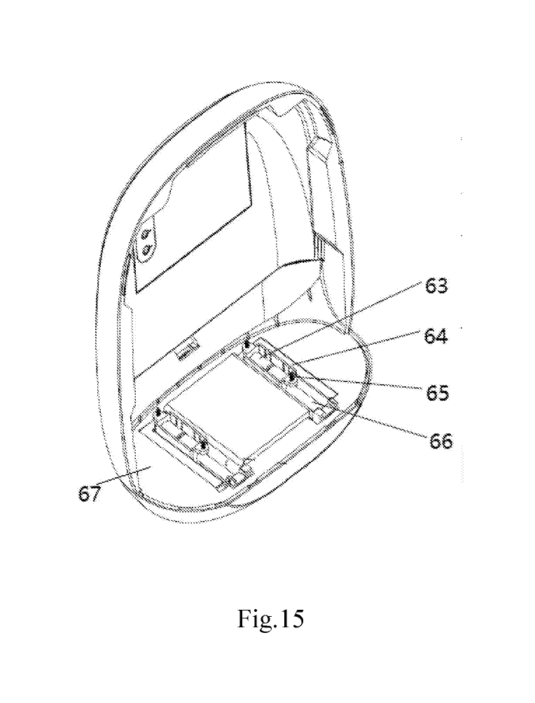

As shown in FIG. 15, the sliding module may comprise a guide sleeve 63, a guide post 66, and a slider 64 provided with the guide sleeve therein. The guide sleeve 63 and the guide post 66 are slidably connected. The slider 64 and the water path upper plate 13 are fixedly connected.

The sliding module may further comprise a sliding component and a guide rail. The sliding component is slidably connected to the guide rail and is a translating slider, or a rolling pulley block, or a ball or a ball set.

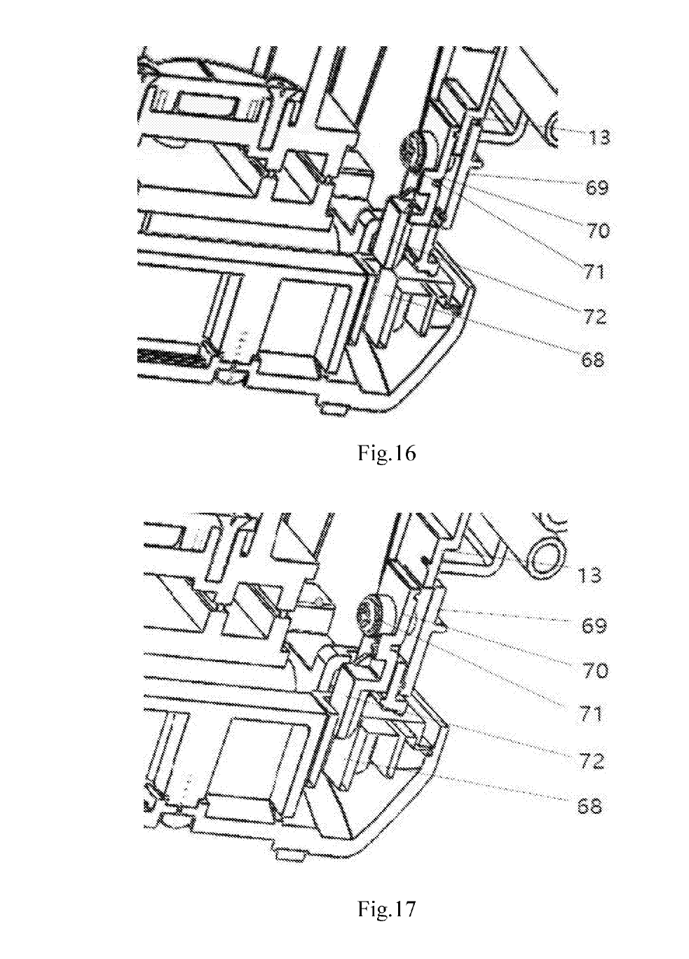

The water purifier further comprises a locking module 60 for fixing the water path upper plate 13 on the water purifier base 67. As shown in FIGS. 16 and 17, the locking module 60 is mounted on the water path upper plate 13 by a fixing screw 65. Wherein the locking module 60 comprises a locating member and a locating groove 68 which matches with the locating member. The locking module 60 further comprises a force receiving member 69 for achieving the movement of the locking pin by pulling the force receiving member 69; a connector 70 configured to connect the force receiving member 69 and the locating member 72; and the locating member 72 which is configured to cooperate with the locating groove 75 to realize fixing or unlocking of the water path upper plate 13. The force receiving member 69 and the connector 70 are an integral structure, which is connected to the force receiving member 69 by a connecting screw 71.

In this embodiment, by pulling the force receiving member 69 in a direction 61, the locating member 72 is allowed to be located above the locating groove 68 (as shown in FIG. 16), and thus the water path upper plate 13 is unlocked and can be pushed and pulled. In the case that the force receiving member 69 is pushed in a direction opposite to the direction 61, the locating member 72 is caught in the locating groove 68 (as shown in FIG. 17), and the water path upper plate 13 is fixed.

Referring to FIGS. 1 to 3, in the case that the number of the filter cartridge bases 1 and the number of the filter cartridges 59 are both three, the filter cartridge base 1 being in communication with the water inlet passage 18 is the first filter cartridge base, and the filter cartridge bases 1 connected in series downstream the first filter cartridge base are the second filter cartridge base and the third filter cartridge base in turn.

The water channel between the first filter cartridge base and the second filter cartridge base is the first water channel.

The water channel between the third filter cartridge base and the second filter cartridge base is the second water channel.

The water outlet passages connecting to the second filter cartridge base and the third filter cartridge base are the second water outlet passage and the third water outlet passage respectively.

It is to be noted that the direction of the arrow in FIG. 1 indicates the flowing direction of water in the filter cartridge base 1, as shown in FIG. 1. The filter cartridges respectively corresponding to the first filter cartridge base, the second cartridge base and the third filter cartridge base are the first stage filter cartridge, the second stage filter cartridge and the third stage filter cartridge. The water first enters the water inlet pipe 26 and flows into the water inlet passage 18, then flows through the first stage filter cartridge, then flows out of the first stage filter cartridge and flows into the second stage filter cartridge through the first water channel, further flows out of the second stage filter cartridge and flows into the third stage filter cartridge through the second water channel. In this case, if the water outlet passage 19 of the second stage filter cartridge is closed and the water outlet passage 19 of the third stage filter cartridge is opened, the purified water flowing through the first stage filter cartridge, the second stage filter cartridge and the third stage filter cartridge may flow out of the water outlet pipe 27. If the water outlet passage 19 of the third stage filter cartridge is closed and the water outlet passage 19 of the second stage filter cartridge is opened, the purified water flowing through the first stage filter cartridge and the second stage filter cartridge can flow out of the water outlet pipe 27. Thus, the object of outputting multiple kinds of water is achieved by the plate-type water path structure.

Referring to FIGS. 1, 3, 5 to 7, one water purifier provided by an embodiment of the present application further comprises a flow meter 21. Wherein the first water channel is provided with a first flow meter, and the second water channel or the third water outlet passage is provided with a second flow meter.

The water purifier further comprises: a wire 6 and a controller 22 provided with a chip inside. The first flow meter and the second flow meter are both connected to the controller 22 via a wire 6, and the controller 22 is provided with three buttons A, B and C which respectively correspond to the filter cartridges 59 in a one-to-one corresponding manner.

It is to be noted that, in this embodiment, the controller 22 is provided with the three buttons A, B and C respectively corresponding to the first stage filter cartridge, the second stage filter cartridge, and the third stage filter cartridge. All the water passing through the first stage filter cartridge and the second stage filter cartridge can be metered by the first flow meter as Q1, and only the water passing through the third stage filter cartridge may be metered by the second flow meter as Q2. Hence, the flowed amount through the third stage filter cartridge is Q2, and the total flowed amount through the first stage filter cartridge and the second stage filter cartridge is Q1. When to replace the filter cartridges 59, it needs to press the button, for example, when the button A is pressed, the counting of the service life of the first stage filter cartridge is re-started, that is, the first stage filter cartridge is defaulted to a new filter cartridge. A chip is set on the controller 22, and the chip may record the numerical value Q11 of the flowed amount Q1 of the flow meter at the start time. The service life of the first stage filter cartridge is designed as Q10, hence, when the reading of Q1 of the first flow meter is equal to Q11+Q10, the service life of the first stage filter cartridge finishes; and when the reset button B is pressed, the chip on the controller 22 will record the reading Q111 of Q1 of the flow meter at this time, and in this case, the second stage filter cartridge is defaulted to have been replaced as a new filter cartridge, and the service life of the second stage filter cartridge is Q110, when the reading of Q1 of the flow meter reaches Q111+Q110, the service life of the second stage filter cartridge finishes. Though the first stage filter cartridge and the second stage filter cartridge use commonly one flow meter 21, the service lives of the two filter cartridges 59 can be detected separately, and the service lives calculated will be displayed on the screen of the water purifier via digital tubes.

Calculation Formula:

Both the first flow meter and the second flow meter employ Hall sensors to meter, and when the water flows through the flow meter, electric signal pulses will be generated, and the amount of water flowing through corresponding to each pulse is q. The chip on the controller 22 may record the number of pulses t. When the reset button A, B or C is pressed, the number of pulses is started to be recorded separately.

Service life of the first stage filter cartridge:

q*t1=QQ1
q—the flowed amount corresponding to per unit of pulse
t1—the number of pulses flowed through the first stage filter cartridge
The service life of the first stage filter cartridge will be set by the system as QQ10.

If:

QQ10−QQ1=0,
it represents that the service life of the first stage filter cartridge finishes.

Service Life of the Second Stage Filter Cartridge:

q*t2=QQ2
q—the flowed amount corresponding to unit pulse
t2—the number of pulses flowed through the second stage filter cartridge

The service life of the second stage filter cartridge will be set by the system as QQ20.

If QQ20-QQ2=0,
it represents that the service life of the second stage filter cartridge finishes.

Service Life of the Third Stage Filter Cartridge:

q*t3=QQ3
q—the flowed amount corresponding to unit pulse
t3—the number of pulses flowed through the third stage filter cartridge
The service life of the third stage filter cartridge will be set by the system as QQ30.

If QQ30−QQ3=0,
it represents that the service life of the third stage filter cartridge finishes.

Note: the counting of the number of pulses t1, t2 and t3 are started respectively after the reset buttons A, B and C are pressed down.

In an embodiment of the present invention, after the reset button A, B or C is pressed, the chip on the controller may record the number of pulses generated by the first flow meter or the second flow meter, and the chip calculates real time service life of the corresponding filter cartridge according to the number of pulses and the flowed amount corresponding to unit pulse. After calculating and obtaining the real time service life of the filter cartridge, the chip compares the real time service life of the filter cartridge with a preset maximum value of the service life of the filter cartridge, if the real time service life of the filter cartridge is not less than the preset maximum value of the service life of the filter cartridge, the service life of the filter cartridge displayed on the display screen of the water purifier is zero.

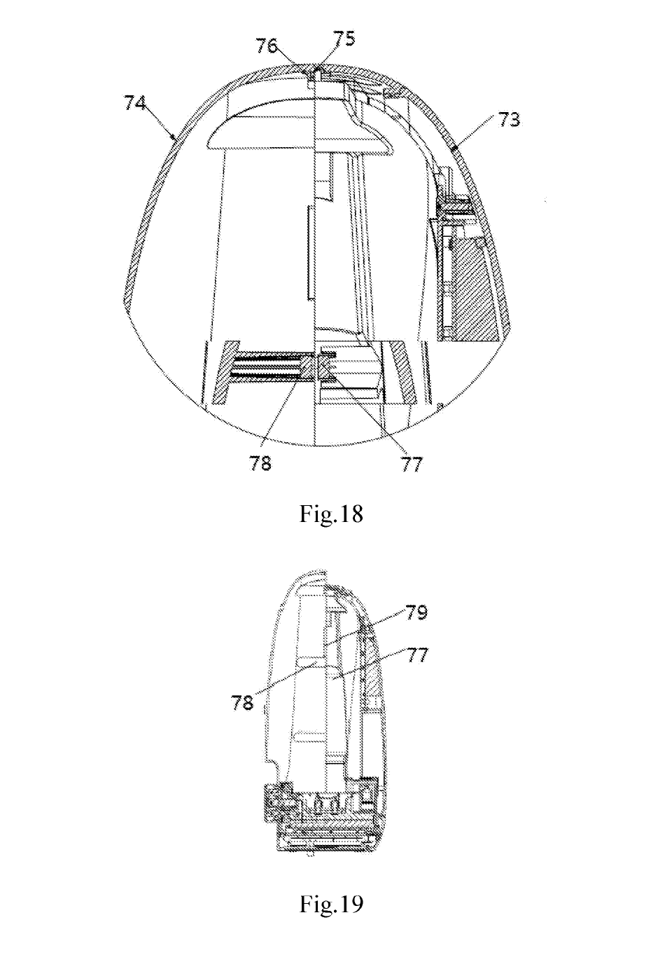

Reference may be made to FIGS. 18 to 21, one water purifier provided by an embodiment of the present application further comprises a front cover 73 and a rear cover 74 connected to the water purifier base 67, and magnets arranged in the front cover 73 and the rear cover 74.

The rear cover 74 and the front cover 73 are movably connected by the magnetic force between the magnets.

The magnet 78 of the rear cover and the magnet 77 of the front cover are located corresponding to each other, and the opposing sides of the magnet 78 of the rear cover and the magnet 77 of the front cover are of opposite magnetic poles.

The number of the magnets in the rear cover 74 and the number of the magnet in the front cover 73 are the same and are at least two.

The water purifier further comprises: a convex-shaped fastener 76 arranged on the top end of the rear cover 74, a fastening groove 75 matching with the convex-shaped fastener 76 arranged in the top end of the front cover 73, and a second position-limiting structure 79 arranged on the front cover 73. Furthermore, the portion, connected to the rear cover 74, of the front cover 73 is provided with a sliding groove, and the portion, in contact with the front cover 73, of the rear cover 74 is provided with a bump capable of protruding into the sliding groove, and the relative sliding between the front cover and the rear cover can be achieved by means of the sliding groove and the bump.

Specifically, when the rear cover 74 and the front cover 73 are movably connected to each other by the magnetic force between the magnets, the convex-shaped fastener 76 on the rear cover 74 is fastened into the fastening groove 75 in the front cover 73 at the same time, thus ensuring that the rear cover 74 cannot be pulled open in the magnetic force direction of the magnets. When it requires to open the rear cover 74, it needs to pull upwards the rear cover 74 (in a direction perpendicular to the magnetic force), after the rear cover 74 is pulled upwards by a certain distance (as shown in FIG. 19), the magnet comes into contact with the second position-limiting structure 79 on the front cover 73, to restrict the rear cover 74 from further being pulled upward, thus the magnets are offset from each other, and the convex-shaped fastener 76 is disengaged from the fastening groove 75, and then the rear cover 74 (as shown in FIG. 21) is rotated, and is then separated.

The structures of the various parts are described in a progressive manner in this description. The structure of each of the parts is mainly focused on describing its differences from the prior art structure, and the overall and partial structure of the water purifier may be obtained by combining the structures of the various parts.

Based on the above description of the disclosed embodiments, those skilled in the art are capable of carrying out or using the present invention. It is obvious for those skilled in the art to make many modifications to these embodiments. The general principle defined herein may be applied to other embodiments without departing from the spirit or scope of the present invention. Therefore, the present invention is not limited to those embodiments illustrated herein, but should be defined by the broadest scope consistent with the principle and novel features disclosed herein.

1. A water purifier, comprising:
a composite water path structure, comprising a water inlet passage, a plurality of water outlet passages, and at least three filter cartridge bases connected in series and in communication with each other via a water channel, wherein the water inlet passage is in communication with the filter cartridge base, located at a start end, of all of the filter cartridge bases connected in series, and the plurality of water outlet passages are respectively in communication with the rest plurality of filter cartridge bases, and the water outlet passage is provided with a valve configured to control its opening and closing;
a filter cartridge, fixed onto the filter cartridge base and in communication with the filter cartridge base, and comprising a multi-stage filtering structure;
a universal direction water outlet structure via which an external water inlet pipe is in communication with the water inlet passage and an external water outlet pipe is in communication with the water outlet passage, and the universal direction water outlet structure being rotatable with respect to the composite water path structure;
a housing, comprising a base and a front cover fixedly connected, and a rear cover detachably connected to the front cover by a magnet;
a replacement device, comprising a sliding module slidably connecting the base and the composite water path structure, to allow the composite water path structure to slide on the top surface of the base, and a locking module configured to lock the composite water path structure and the base; and
a detection device, comprising a plurality of flow meters arranged on the water channel, with any adjacent two filter cartridge bases being provided therebetween with the flow meter; and a controller electrically connected to all of the flow meters via a wire, and configured to monitor and record the flowed amount of water and capable of resetting the numerical value of the flowed amount.

2. The water purifier according to claim 1, wherein
the composite water path structure is formed by splicing a water path upper plate, a water path lower plate, and a rib arranged on the water path upper plate and the water path lower plate, and the filter cartridge base is fixed onto the water path upper plate; and
both the number of the filter cartridge bases and the number of the filter cartridges are three, and the filter cartridge base in communication with the water inlet passage is the first filter cartridge base, and the filter cartridge bases connected in series downstream the first filter cartridge base are sequentially the second filter cartridge base and the third filter cartridge base, and the water channel between the first filter cartridge base and the second filter cartridge base is the first water channel, and the water channel between the third filter cartridge base and the second filter cartridge base is the second water channel.

3. The water purifier according to claim 2, wherein all of the filter cartridge bases have the same structure, and each comprise a filter cartridge water outlet port, a filter cartridge water inlet port, a connecting plate, a pressing plate, a sealing ring, a water channel inlet port, a water channel outlet port, and a fastening screw;
both the filter cartridge water outlet port and the filter cartridge water inlet port are arranged on the connecting plate;
the filter cartridge water outlet port and the filter cartridge water inlet port are butt-joined to the water channel outlet port and the water channel inlet port respectively, and are sealed by the sealing ring, and in every adjacently arranged two filter cartridge bases, the filter cartridge water inlet port of the upstream one is in communication with the filter cartridge water outlet port of the downstream one, and the filter cartridge water outlet ports of the second filter cartridge base and the third filter cartridge base are respectively in communication with the second water outlet passage and the third water outlet passage of a plate-type water outlet passage;
the connecting plate is arranged between the pressing plate and the water path upper plate; and
the pressing plate is fixed onto the water path upper plate by the fastening screw.

4. The water purifier according to claim 2, wherein,
the connecting plate is a rotatable connecting plate;
the filter cartridge base further comprises a first position-limiting structure configured to restrict the rotatable connecting plate; and
the first position-limiting structure consists of a column distributed on the connecting plate, and a circular-arc slot distributed on the water path plate.

5. The water purifier according to claim 1, wherein the filter cartridge comprises a first filtering structure and a second filtering structure, wherein the first filtering structure comprises: a central tube; a folded filter membrane sleeved outerside the central tube, with a second cavity being arranged between the filter membrane and the central tube; and a housing sleeved outside the filter membrane, with a first cavity being arranged between the housing and the filter membrane.

6. The water purifier according to claim 5, wherein the housing comprises a cylindrical housing body, a top cover provided with a recess, a bottom cover provided with a water inlet/outlet assembly, wherein:
the top end opening of the central tube is an inclined port, and is inserted into the recess, and the bottom end of the central tube has a sealing ring sleeved thereon;
a separator is provided respectively between the first cavity and the bottom cover and between the second cavity and the bottom cover;
the water inlet/outlet assembly comprises: a straight water inlet port and a straight water outlet port which are in communication with the filter cartridge base, a side water inlet port, a side water outlet port and a switch structure;
the straight water inlet port is in communication with the first cavity via the side water inlet port; and
the straight water outlet port is in communication with the central tube via the side water outlet port.

7. The water purifier according to claim 6, wherein the switching structure comprises a spring and a rubber ball distributed at the top end of the straight water inlet port and the straight water outlet port; and
the rubber ball is arranged respectively between the spring and the straight water outlet port and between the spring and the straight water inlet port.

8. The water purifier according to claim 6, wherein the second filtering structure comprises:
a third cavity arranged inside the housing and located at the bottom of the first filtering structure, wherein the central tube is in communication with the water inlet/outlet assembly via the third cavity; and
a filter material provided in the third cavity and capable of filtering heavy metal ions.

9. The water purifier according to claim 6, wherein the second filtering structure is a sintered active carbon rod arranged between the filter membrane and the central tube, and the second cavity is located between the sintered active carbon rod and the central tube.

10. The water purifier according to claim 6, wherein the second filtering structure is a mineral substance layer having an adding function arranged in the first cavity.

11. The water purifier according to claim 1, wherein the universal direction water outlet structure comprises:
a water inlet/outlet joint in connection and communication with the external water inlet pipe and the external water outlet pipe, and a water path joint in connection and communication with the water inlet passage and the water outlet passage, the water path joint is a multilayer recessed structure consisting of a plurality of circular grooves sleeved co-axially with gradually decreased internal diameters;
the number of layers of the recessed structure and the number of the circular grooves are equal to each other, and are equal to the sum of the number of the water inlet passage and the number of the water outlet passage;
the water inlet/outlet joint is provided with a plurality of layered passages, and the plurality of layered passages are matchfully muff-coupled to and one-to-one communicated with the plurality of circular grooves; and
a clamp assembly locking the water inlet/outlet joint and the water path joint, and allowing both of them to rotate with respect to each other.

12. The water purifier according to claim 11, wherein the clamp assembly comprises:
two semi-circular clamps capable of being butt-jointed, and the two clamps being capable of cooperatively clamping the flanges of the water inlet/outlet joint and the water path joint; and
a locking screw connecting the two clamps.

13. The water purifier according to claim 11, wherein both the water inlet/outlet joint and the water path joint are a stepped inverted cone structure, and the water inlet/outlet joint is provided with a sealing ring at the outlet of each passage.

14. The water purifier according to claim 1, wherein both the font cover and the rear cover are provided with a plurality of the magnets, and the number and position of the provided magnets in the front cover one-to-one correspond to the number and position of the provided magnets in the rear cover.

15. The water purifier according to claim 14, wherein the portion, connected to the rear cover, of the front cover is provided with a sliding groove, and the portion, in contact with the front cover, of the rear cover is provided with a bump capable of protruding into the sliding groove, and the relative sliding between the front cover and the rear cover can be achieved by means of the sliding groove and the bump.

16. The water purifier according to claim 15, further comprising:
a convex-shaped fastener arranged at the top end of the rear cover, and a fastening groove arranged at the top end of the front cover and capable of being fastened to the convex-shaped fastener; and
a second position-limiting structure arranged on the front cover and configured to prevent the rear cover from exceedingly sliding with respect to the front cover.

17. The water purifier according to claim 2, wherein the water path upper plate is vertically fixed to the top of the sliding module, and the sliding module comprises:
slidably connected guide sleeve and guide post, wherein the guide sleeve is arranged inside a slider, and the slider is fixedly connected to the water path upper plate; and
slidably connected sliding component and guide rail, wherein the sliding component is a translating slider, or a rolling pulley block, or a ball, or a ball set.

18. The water purifier according to claim 2, wherein the locking module is fixed onto the base by a fastening screw, and the locking module comprises:
a locating member arranged on the composite water path structure, and translating along with the composite water path structure; and
a locating groove provided on the base, and capable of fastening the locating member;
a force receiving member arranged on the surface of the composite water path structure and configured to drive the locating member to move; and
a connecting member, configured to connect the force receiving member and the locating member, wherein the locating member and the connecting member are an integral structure and are connected to the force receiving member via a connecting screw.

19. The water purifier according to claim 2, wherein the flow meter comprises a first flow meter arranged on the first water channel, and a second flow meter arranged on the second water channel, and the controller is provided with buttons respectively configured to reset the numerical value of the flowed amount through the three filter cartridges.
